(19) United States
(12) Patent Application Publication
(10) Pub. No.: US 2008/0183500 A1
(43) Pub. Date: Jul. 31, 2008

(54) SYSTEMS AND PROCESSES FOR HEALTH MANAGEMENT

(76) Inventor: MICHAEL H. BANIGAN, Frisco, TX (US)

Correspondence Address: CARSTENS & CAHOON, LLP, P O BOX 802334, DALLAS, TX, 75380, US

(21) Appl. No.: 11/627,874

(22) Filed: Jan. 26, 2007

(51) Int. Cl. G06F 19/00

(52) U.S. Cl. 705/3

(57) ABSTRACT

Systems and processes for health management may include a website for managing diseases and/or therapies. Questions based on user information, such as a health condition and/or treatment regimen of the user, may be presented on the website. Answers to the questions may be received and analyzed. A response may be determined based on the analysis of the answers. A user may also request prescription refills using the website.

### TECHNICAL FIELD

This invention relates to health management, and more particularly to disease and therapy management.

### BACKGROUND

Patients with chronic and/or life-altering diseases (e.g., diabetes, Crohn's disease, colorectal cancer, etc.) may have complex healthcare issues and experience varying degrees of symptoms associated with their disease and their drug treatment on a daily basis. Thus, treating and tracking disease progression and side effects of therapy in these patients may be difficult since symptoms may not manifest during medical treatment or sporadic interaction with patients. In addition, doctors, managed care providers, and other third parties involved in a patients' continuum of care may not have a complete and/or accurate picture of the compliance with treatment and health status between appointments.

Managed care organizations and health insurance companies may have disease management programs to ensure that patients with chronic and life-altering diseases comply with specific medical protocols since standards of care are increasingly important to managing disease and quality of life. Among the treatment protocol of patients diagnosed with chronic and life-altering disease is an emphasis and importance on patients being compliant and persistent with their physician prescribed drug therapy. Compliance with drug treatment regimens often decreases medical expenses for the health insurance companies, and decrease exacerbations of symptoms while increasing quality of life for the patient. Managed care organizations and other health entities typically use disease management programs that require nurses and health professionals to visit, call, or interact with patients in the program to determine patient compliance with treatment regimens, general patient health, and disease progression. However, often nurses do not reach each patient on the first attempt and must repeatedly try to contact the patient until the patient is contacted. In addition, many of the patients do not experience worsening conditions, adverse events, or conditions that require medical or treatment intervention. Therefore, there is little value in interaction with a nurse or other health professional; and thus time may be wasted trying to contact, often multiple times, a patient experiencing no significant events.

### SUMMARY

This disclosure is related to symptoms and processes for health management. In particular, systems and processes for disease and/or therapy management are disclosed.

In one general aspect, a process for health management may include receiving a request for access to a website, presenting questions based on user information, receiving answers to the questions, analyzing the answers received, and determining a response based on the analysis of the answers. The questions may include questions related to a health condition of the user.

Implementations may include one or more of the following features. Questions may include questions related to a disease of a user, a treatment of a health condition of a user, and/or symptoms of a user. One or more options for an answer to a question may be presented. Options for an answer may include a range of answers. Analyzing the answers may include comparing the answers received to answers previously received. A determination may be made whether the answers received from a user are within an allowable tolerance of answers previously received. The response may include transmitting a notice to a health care provider to contact a user and/or transmitting a notice to schedule an appointment with a doctor. Notice to schedule an appointment with a doctor may be transmitted and a request for an appointment with a doctor may be received. Answers to the questions may be received from a plurality of users. The answers from a plurality of users may be analyzed and at least one of: patient compliance among the plurality of users; patient persistence among the plurality of users; treatment efficacy among the plurality of users; pharmaco-economic information or disease progression among a plurality of users may be determined.

In another general aspect, a process for health management may include receiving a request for access to a website from a user, accessing prescription records based on user information, receiving a request to refill one or more prescriptions from the user, and determining patient compliance based on the prescription records and the request.

Implementations may include one or more of the following features. A request to refill one or more prescriptions may be transmitted to a pharmacy. A bill associated with the request to refill one or more prescriptions may be transmitted to a payer. Determining patient compliance may include determining an amount of time lapsed between receiving the request to refill a prescription and the previous request to refill the same prescription. Effectiveness of a treatment may be determined based at least in part on the determined patient compliance. Questions may be presented based on: user information; answers may be received to the questions; the answers received may be analyzed; and a response may be determined based on the analysis of the answers. Questions may include questions related to a health condition of the user. Patient compliance may be compared to the answers to the questions to determine the effectiveness of a treatment. A request may be received for supplies related to a health condition of a user.

Various implementations may have one or more features. For example, a health management system may facilitate disease and/or therapy management. Determining responses based on an analysis of the answers provided by a user may decrease costs associated with health management (e.g., disease and/or treatment management). For example, nurses or other healthcare providers may only follow up (e.g., via a phone call, e-mail, or instant message) with users whose answers deviate more than an allowable tolerance from previous answers. A health management system may also encourage and promote compliance with treatment regimens. Increasing patient compliance with treatment regimens may reduce costs for healthcare providers and/or improve quality of life for the user. Furthermore, analyzing answers from a plurality of users may allow healthcare providers, pharmaceutical companies, and/or other interested parties to obtain pharmaco-economic data, and/or data regarding treatment efficacy, side effects, disease progression during treatment and/or when users do not comply with treatment regimens, and/or symptoms among a plurality of users. Another feature of the health management system includes the ability to make changes without downloading the changes to the various user interface devices. For example, since the website may be stored and/or generated by a data management device, changes (e.g., updates, changes to the appearance of the website, changes to questions associated with certain health conditions, changes to the listing of questions in a database coupled to the data management server, software changes and/or updates, etc.) may be implemented in the data management system. In addition, since the website may store data such as user information, answers to questions presented, and/or analysis of the answers (e.g., to determine patient compliance, patient persistence, therapy efficacy, side effects, symptoms, disease progression, pharmaco-economic data, etc.), data may be aggregated. Aggregated data may facilitate pharmaco-economic analysis, treatment efficacy analysis, disease progression with specified treatments, and/or patient compliance with treatment analysis, for example. In addition, the website may automatically notify, as appropriate, healthcare providers, payers, and/or pharmaceutical companies of analysis of answers provided by users.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates an example of a system for health management in accordance with certain implementations of the present disclosure.

FIG. 2 illustrates an example process for health management in accordance with one implementation of the system of FIG. 1.

FIG. 3 illustrates an example of a process for health management in accordance with one implementation of the system of FIG. 1.

FIG. 4 illustrates an example of a process for health management in accordance with one implementation of the system of FIG. 1.

FIG. 5 illustrates an example of a process for refilling a prescription in accordance with one implementation of the system of FIG. 1.

Like reference symbols in the various drawings indicate like elements.

### DETAILED DESCRIPTION

An automated health management system may be used to manage and/or monitor user health (e.g., disease management, therapy management, etc.). Aggregate information across a plurality of users may also be obtained using the health management system. Users may include people with health conditions. The health management system may also be utilized by health care providers (doctors, nurses, physician's assistants, hospitals, clinics, insurance companies, etc.), pharmacies, and/or pharmaceutical companies to monitor health conditions, treatment efficacy, patient compliance, patient persistence, adverse effects from treatments, symptomology, pharmaco-economics, etc.

The health management system may include one or more websites accessible by users, healthcare providers, pharmacies, and/or pharmaceutical companies. The website may present questions to users. The questions may be selected to determine patient compliance, treatment efficacy, symptoms, patient health, etc. The user(s) may answer questions on the website and the answers may be analyzed to determine patient compliance, treatment efficacy, disease progression, patient health, etc. The website may present the analysis (e.g., graphs, charts, etc.) to the users to facilitate management and/or monitoring of the health condition of the users. The users may print the presented analysis to provide to a healthcare provider to facilitate treatment of the health condition of the users.

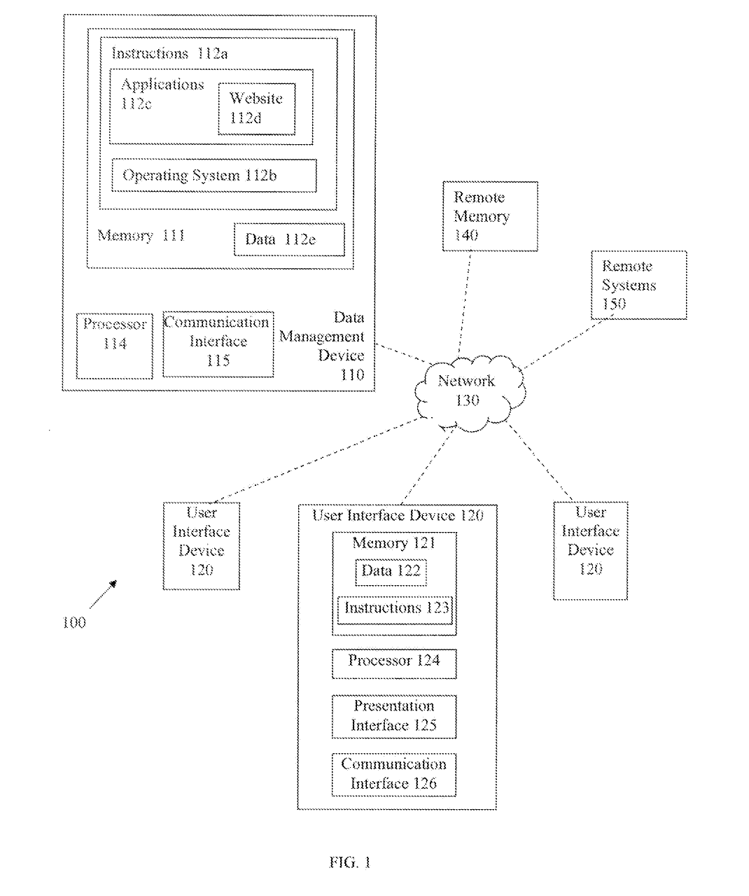

FIG. 1 illustrates an example automated system 100 for health management. System 100 may be a distributed environment that spans one or more networks, such as network 130. System 100 may include a data management device 110 coupled to one or more user interface devices 120 via a network 130.

Data management device 110 may include any computer or processing device such as, for example, a blade server, a general-purpose personal computer (PC), a Macintosh, workstation, a Unix-based computer, or any other suitable device. Data management device 110 may be computers other than servers, a single server, as well as a server pool. Data management device 110 may execute operating systems such as Linux, UNIX, Windows Server, or any other suitable operating system. Data management device 110 may be coupled to a web server, a mail server, and/or other servers.

Data management device 110 includes a memory 111. Memory 111 may include volatile memory and/or nonvolatile memory, such as RAM, ROM, optical memory, magnetic memory, EEPROM, flash memory, etc. Memory 111 may include databases and/or be coupled to remote memories 140, such as intra-enterprise, inter-enterprise, regional, and/or national electronic storage facility, data processing center, or archive that allows one or a plurality of user interface device(s) 120 and/or data management devices 110 to dynamically store and retrieve data (e.g., applications, user information, pharmaceutical information, educational information, prescription information, or any other data useful in the health management system).

Memory 111, 140 may include instructions 112a (e.g., software) and/or data 112e (e.g., user information, prescription records, etc). Instructions may include applications 112c such as operating systems 112b and applications to generate a website 112d to facilitate health management (e.g., disease and/or therapy management). The website may allow interaction with users (e.g., patients), retrieve and/or generate lists of questions for a user to answer, be capable of receiving answers to the lists of questions, and/or analyze answers to facilitate management of the health of a user. Applications 112c may also present results of the analysis of answers to questions (e.g., individualized results and/or aggregate results). User information may include user name; user password; contact information such as address, phone number, or e-mail address; age; weight; health conditions, such as diseases, metal health, and/or other conditions related to the health of a user; current treatment regimens (e.g., medicinal regimens); health care provider identities (e.g., insurance information, doctor identity, etc.); and/or any other information that facilitates health management. Prescription records may include identity of pharmaceuticals and/or nutraceuticals, dosages, necessary supplies (e.g., syringes, testing strips, etc.), quantity of refills prescribed, healthcare provider (e.g., doctor, nurse, health insurance companies), previous requests for refills, etc. User information may be supplied by a user, health care providers, pharmacies, and/or other third parties.

Memory 111 may also include any other appropriate data such as VPN applications or services, firewall policies, a security or access log, print or other reporting files, HTML files or templates, child software applications or sub-systems, and others. For example, access to a website generated by data management device 110 may be restricted. Access may require entry of a valid user name and/or password. Access may be restricted to users registered with the health management system. In addition, access levels may vary based on user information (e.g., identity of the user). For example, a user may be able to access information related to the user's health condition and/or may be able to access analysis of answers the user provided. The user may be restricted from accessing user information, answers to questions, and/or analysis of answers for other users. As another example, a health care provider, such as a doctor, may be able to access information (e.g., answers to questions and/or analysis of answers) for patients associated with the doctor (e.g., the doctor is listed in the user information and/or the health management system associates the user with the doctor). Furthermore, health care providers such as insurance companies may be able to access information (e.g., answers to questions and/or analysis of answers) for users associated with the health care provider and/or users associated with other health care providers. In some implementations, a health care provider may be able to access information regarding a plurality of users with similar health conditions.

Data management device 110 also includes a processor 114 that executes instructions and manipulates data to perform operations of data management device 110. Processor 114 may include, for example, a central processing unit (CPU), a blade, an application specific integrated circuit (ASIC), and/or a field-programmable gate array (FPGA). Although FIG. 1 illustrates a single processor 114 in data management device 110, multiple processors 114 may be used according to particular needs and reference to processor 114 is meant to include multiple processors 114, where applicable.

Data management device 110 additionally includes a communication interface 115 that allows communication between data management device 110 and user interface device(s) 120, remote memory 140, and/or remote systems 150 (e.g., pharmacies, health care providers, payers such as insurance companies, charitable organizations, etc.). Communication interface 115 may transmit data from data management device 110 to, and/or receive data from user interface device 120, remote memory 140, and/or remote systems 150 via various network protocols (e.g., TCP/IP, Bluetooth, and/or Wi-Fi) and communication links (e.g., wireline, wireless, and/or fiber optic). For example, communication interface 115 may transmit and/or receive data from user interface devices 120, remote memory 140, and/or remote systems 150 via network 130 (e.g., Internet, LAN, WLAN, wireless, WAN, etc).

User interface device 120 may be any computer or processing device such as, for example, a general-purpose personal computer (PC), a Macintosh, a workstation, a laptop computer, a personal digital assistant (PDA), a smart phone, a cellular phone, or any other suitable device. User interface device 120 may include memory 121, including volatile and/or nonvolatile memory storing instructions 122 and data 123, and a processor 124 that executes instructions and manipulates data to perform operations of the user interface device. User interface device 120 may also include a presentation interface 125 to present data such as websites and/or questions generated by data management device 110. For example, presentation interface may present data in visual and/or audio format. Presentation interface 125 may include display device, such as a screen, and/or speakers. Presentation interface 125 may display a graphical interface of a website generated by data management device 110.

User interface device 120 also may include a communication interface 126 that allows communication with data management device 110, other user interface devices 120, remote memory 140, and/or remote systems 150. Communication interface 115 may transmit data from host 110 to, and/or receive data from data management device 110, remote memory 140, and/or other remote systems 150 via network protocols (e.g., TCP/IP, Bluetooth, and/or Wi-Fi) and/or bus (e.g., serial, parallel, USB, and/or FireWire).

In some implementations, a user may access a website of a health management system, such as system 100 illustrated in FIG. 1, to manage a health condition (e.g., diseases, conditions, cancer, etc.) of the user. A user may utilize the health management system to facilitate the management of chronic and life-altering diseases (e.g., diabetes, asthma, sickle cell anemia, breast cancer, Crohn's disease, ceriac disease, rheumatoid arthritis, depression, etc.). Management of chronic and life-altering diseases may improve the health or the quality of life of a user and/or decreases costs associated with treating a user by facilitating better management, reporting, oversight, treatment compliance, and treatment efficacy.

A user may provide answers to questions presented on the website periodically (e.g., once a month, once a week, bimonthly, quarterly, etc.). A user may be required (e.g., by a healthcare provider, program manager, etc.) to access the website and answer questions periodically. A user may be allowed to answer questions each time the user visits the website of the health management system. Questions presented to the user may be selected by the health management system from a database of questions based on user information (e.g., health condition, age, weight, course of treatment, etc.). At least a portion of the questions presented to the user may be similar on subsequent visits to the website.

Answers to questions presented may be analyzed, such as by comparing the answers to previously submitted answers and/or to acceptable answers in a database (e.g., acceptable glucose levels, peak flow readings, dietary guidelines, etc.). In some implementations, similar questions may be asked to users each time a user answers questions to allow disease progression and/or treatment efficacy to be tracked.

In some implementations, health management system may allow changes to be made to the health management system without downloading the changes to the various user interface devices. For example, since the website may be stored and/or generated by a data management device, changes (e.g., updates, changes to the appearance of the website, changes to questions associated with certain health conditions, changes to the listing of questions in a database coupled to the data management server, software changes and/or updates, etc.) may be implemented in or on the data management system. Allowing changes to be centrally performed (e.g., on data management server) may facilitate management of health management system and/or facilitate health management (e.g., since as information is known or discovered about health conditions, the health management system may be updated). In addition, since the website may store data such as user information, answers to questions presented, and/or analysis of the answers (e.g., to determine patient compliance, patient persistence, therapy efficacy, side effects, symptoms, disease progression, pharmaco-economic data, etc.), data may be aggregated. Aggregated data (e.g., among a plurality of users and/or plurality of health conditions) may facilitate pharmaco-economic analysis, treatment efficacy analysis, disease progression with specified treatments, and/or patient compliance with treatment analysis, for example. In addition, the website may automatically notify, as appropriate, healthcare providers, payers, and/or pharmaceutical companies of analysis of answers provided by users, which may facilitate user compliance with disease management programs (e.g., since less reporting may be required by users) and increase the availability of data to healthcare providers, pharmaceutical companies, pharmacies, and/or other organizations (e.g., since data may be automatically transmitted to the interested parties rather than requiring the interested parties to individually contact users to obtain data).

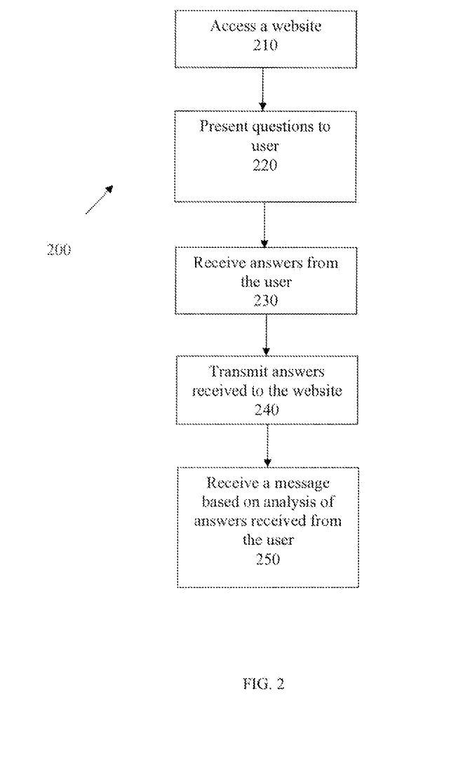

FIG. 2 illustrates a process 200 for health management. Process 200 may be performed by a user interface device 120 using health management system 100, as illustrated in FIG. 1. In process 200, a website may be accessed (operation 210). A website for health management may, for example, be generated by data management device 110. User interface device 120 (e.g., computer, smart phone, etc.) may be utilized by a user to access, via network 130, the website for health management. A user may logon to the health management website and/or one or more cookies stored on user interface device 120 may identify and/or authenticate the user to data management device 110.

Questions may be presented (operation 220). For example, questions may be presented on a display device (e.g., LCD monitor, CRT monitor) of the user interface device. Questions presented may relate to the health condition of the user (e.g., symptoms, side effects from treatment regimens, etc.), the course of treatment of a health condition of the user, treatment for other health conditions of the user (e.g., headaches, colds, flu, etc.), the course of treatment of other health conditions (e.g., identities and/or dosages of prescriptions or other drugs used in treatment, nutraceuticals or other supplements used in treatment, etc.), disease progression, quality of life issues, and/or and general well-being. One or more of the questions may have been previously presented. As an example, a user may be asked to rate the intensity of the pain in a portion of the user's body. As another example, the user may be asked if the user experiences pain at the injection site. Questions may also include one or more of the following, without limitation: how do you feel today; do you feel better than you did one month ago; how strong is the pain you are feeling, do you have any reactions at the injection site; are you taking your medicine according to the treatment regimen; what medications are you taking; are you taking aspirin once a day in the evening; how long has it been since your last appointment; what symptoms are you experiencing; are you experiencing headaches; are you experiencing vomiting; are you experiencing any of the following side effects from your treatment regimen.

The answers to the questions presented may be received from a user (operation 230). For example, the user may input the answer to a question via an input device, such as a mouse, keyboard, touch screen, audio, and/or stylus. Options for answers may be presented to the user. The user may select an answer from options for answers presented to the user. The options of answers available may include a range of answers. For example, a range of answers may include a range of affinities, a range of symptoms, a range of pain, etc. For example, a user may be presented with the following question: “How severe is the pain in your arm?” Options of answer may include a range of answers that reflect varying levels of pain from low to severe. As another example, a user may be presented with the following question: “I feel better today than 1 did last month.” Options for answers may include a range of answers from “I strongly agree” to “I strongly disagree.”

The answers received from the user may be transmitted to the website (operation 240). For example, user interface device 120 may transmit answers received to data management device 110, via network 130. Answers may be stored in a memory of the data management device 110 and/or user interface device 120. The answers to the questions presented may be analyzed (e.g., via the data management device) to facilitate health management of the user (operation 250). As an example, a determination may be made whether a treatment for a patient is effective (e.g., manages pain, reduces symptoms, mitigates disease progression, etc.), whether the patient is complying with treatment for a health condition (e.g., visiting the doctor as directed, taking pharmaceuticals as prescribed, etc.), and/or an appropriate response based on the analysis of the answers.

A response may be received based on the answers (operation 260). For example, responses may include notice that an appointment with a doctor should be scheduled or scheduling an appointment with a doctor. As another example, responses may include contact from a nurse (e.g., via instant messaging, via e-mail, etc.) or a message that a nurse will be contacting the user. In addition, responses may include instructing the user to answer questions again in one month or other period of time and/or a reminder of a treatment regimen prescribed for a user. The response may be displayed on a presentation interface 125 of user interface device 120.

Although FIG. 2 and the accompanying description illustrate example process 200, system 100 contemplates using or implementing any suitable technique for performing these and other processes, which will be discussed below. It will be understood that these processes are for illustration purposes and that described or similar techniques may be performed at any appropriate time, including concurrently, individually, or in combination. In addition, many of the operations in these flowcharts may take place simultaneously and/or in different orders than as shown. Moreover, system 100 may perform processes with additional, fewer, and/or different operations, as long as the processes remain appropriate. For example, a graphical display of the results of the analysis of the answers may be presented on the website.

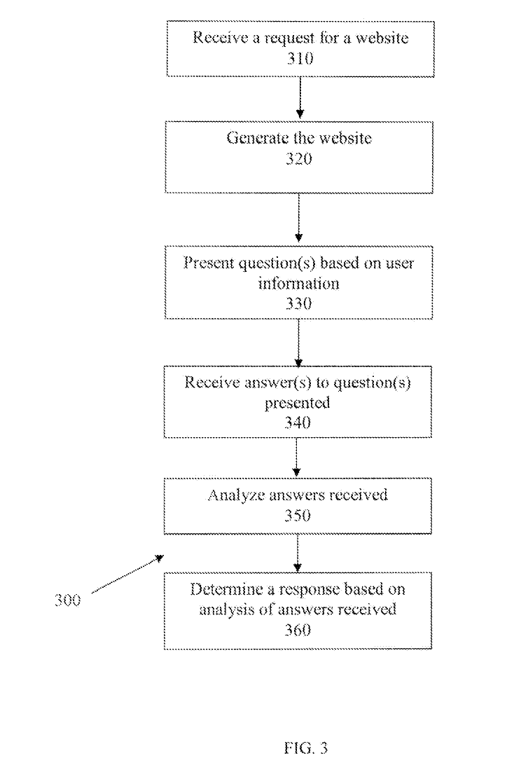

FIG. 3 illustrates an example process 300 for health management. Process 300 may be performed by health management system 100, as illustrated in FIG. 1. A request for access to a website may be received (operation 310). For example, a request from a user interface device 120 may be transmitted to data management device 110 via one or more network protocols. Access to the website for health management may be restricted to authorized users. A request for access to the website may include user information such as user name and password to access the website for health management. In another implementation, a cookie residing on the user interface device 120 may allow the user to access the restricted website.

A website may be generated based on user information by data management device 110 (operation 320). For example, a user may be presented with a greeting including user information (e.g., user name) and/or other customized information (e.g., treatment regimen, doctor's appointment history, prescription information and/or history, etc.).

The website may present questions based on user information (operation 330). User information may be stored at least partially on a memory coupled to a data management device. Data management device 110 may generate a page of a website including one or more questions for a user to answer. Questions may include, for example: was there a reaction at the injection site; did you have pain at the injection site; how severe is the pain; are you taking your medicines as prescribed; are you following your treatment regimen; when was your last appointment at the doctor, etc. The questions may be based at least in part on user information such as a health condition of the user (e.g., disease, physical condition, metal condition, etc.). The questions may include questions previously presented to the user. In some implementations, a memory 111, 140 of a health management system may include a listing of questions. Health management system 100 may select questions from the listing of questions appropriate for the health condition of the user (e.g., injection questions for users on injectable therapies, testing questions for users with diabetes, pain questions for users with chronic back pain, etc.). Listings of questions stored in the health management system may be modified, as appropriate, such as by pharmaceutical companies and/or healthcare providers seeking information.

Answers may be received to the questions presented (operation 340). For example, a user may select an answer from available options. For example, a question may be presented to the user along with options of possible answers to the question. The options for answers may be a range of responses. For example, options for possible answers may include: “strongly agree”; “agree”; “uncertain”; “does not apply”; “disagree”; and “strongly agree”. As another example, a range of answers may include ratings of pain (e.g., from 1 to 10). Options of possible answers may be based on industry standards, guidelines, or commonly used procedures (e.g., Wong-Baker Faces Pain Rating Scale).

The answers received may be analyzed (operation 350). Answers to questions may be analyzed to determine compliance (e.g., compliance with a treatment regimen) and persistence (e.g., how long a user is in therapy). As an example, answers received may be compared to previously received answers. A determination may be made whether the answers received deviate from previously received answers by more than an allowable tolerance. For example, a pain rating of 8 may be received and previously received answers indicate a pain rating of 4. If an increase or decrease of 2 points on a pain rating is an allowable tolerance, then it may be determined that the received pain rating deviates from previously received answers by more than an allowable tolerance.

A response may be determined based on the analysis of answers received (operation 360). For example, answers received may be compared to a database of allowable answers to determine an appropriate response. As another example, a response may be based at least in part on whether answers received deviate from previously received answers by more than an allowable tolerance. In some implementations, answers received may be compared to baseline answers (e.g., previously received answers at a specified time or specified time period, an average of previously received answers over a period of time, etc.). Answers to questions may be analyzed based at least in part on the baseline answers to determine if the answers received deviate from baseline answers by more than an allowable tolerance. For example, a user's indication of pain may increase 1 point each month, which may be within an allowable tolerance of the previous month; however, after 6 months of 1 point increases in the indication of pain, the indication of pain may exceed the allowable tolerance from the baseline answer. Comparison of the answers received to baseline answers may facilitate identification of increasing pain, worsening symptoms, or deviations greater than an allowable tolerance in other answers and thus, facilitate identification of disease progression and/or treatment ineffectiveness.

Responses may include prompting a healthcare provider to contact a user (e.g., via a message to the healthcare provider). Responses may include transmitting a message (e.g., via e-mail, presented on a display device of the user interface device 120, etc.), such as notice that an appointment with a doctor should be scheduled, notice that a healthcare provider (e.g., a nurse or physician's assistant) should contact user, and/or other appropriate responses. For example, a response may include presenting educational material (e.g., information on a health condition of the user, newsletters regarding a health condition of a user, information on a treatment regimen of a user, etc.). As another example, a healthcare provider may request notification when a user's answers to specified questions exceed an allowable tolerance, when compared to previous answers and/or appropriate answers stored in a memory of the health management system 100. In some implementations, a response may include transmitting a message to a nurse (e.g., via e-mail) to contact a user. A nurse may determine whether a doctor's appointment should be scheduled or whether deviations in received answers are not indications of disease progression (e.g., user fell down stairs and thus experienced more pain rather than disease progression). Contacting users when answers deviate more than an allowable tolerance may provide cost-savings to insurance companies and other healthcare providers by allowing early detection of problems with treatment efficacy, patient compliance, etc. In addition, unlike current disease management programs, resources (e.g., nurses or other people who contact users) are not wasted on users who comply with treatment regimens, are not experiencing worsening symptoms, and/or whose health condition is not progressive rapidly.

Although FIG. 3 and the accompanying description illustrate example process 300, system 100 contemplates using or implementing any suitable technique for performing these and other processes. It will be understood that these processes are for illustration purposes and that described or similar techniques may be performed at any appropriate time, including concurrently, individually, or in combination. In addition, many of the operations in these flowcharts may take place simultaneously and/or in different orders than as shown. Moreover, system 100 may perform processes with additional, fewer, and/or different operations, as long as the processes remain appropriate. For example, trends in answers received over a period of time may be determined. Answers received may be compared to answers received from other users to similar questions. As another example, answers received and/or at least a portion of results of the analysis of the answers received may be transmitted.

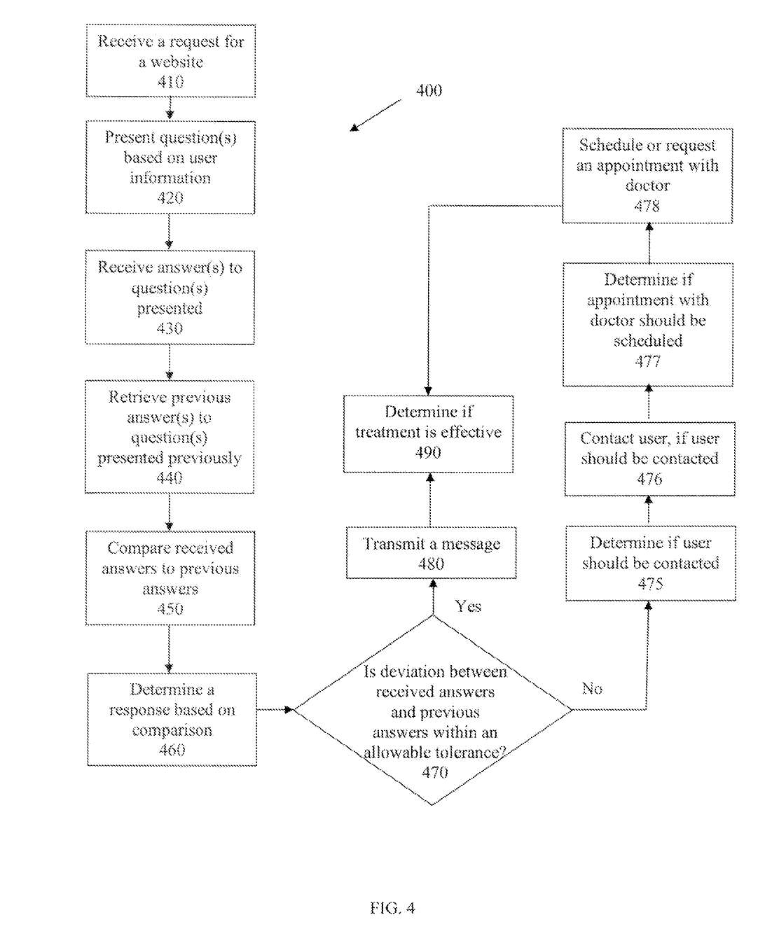

FIG. 4 illustrates an additional example process 400 for health management. Process 400 may be performed by health management system 100 illustrated in FIG. 1. In process 400, a request for a website may be received (operation 410). For example, a user may request access to a website via a PDA. A user may enter user information such as a username and password to access the website. The website may facilitate management of the health of the user.

A list of questions based on user information may be presented (operation 420). For example, the list of questions may be presented on the website and displayed on the presentation interface (e.g., LCD screen) of a PDA. A list of questions may be generated from questions stored in a memory 111, 140 coupled to data management device 110. A list of questions may be generated based on user information such as treatment, health condition, previous list of questions, previous answers to questions, etc.

Answers to questions presented may be received (operation 430). For example, a user may enter and/or select answers on the website presented to the user. In some implementations, options for answers may be presented to the user on the website. For example, the user may be presented a question such as “Have you experienced injection site pain?” A range of answers may be presented to the user, such as “never”, “almost never”, “often”, “frequently”, and “always”. The user may select an answer to the question from the range of answers and/or transmit a different answer. For example, a website may include a portion in which a user may provide supplementary information to answers selected and/or enter an answer rather than selecting an answer from the series of possible answers. As another example, a user may be presented a question such as “What side effects have you experienced?” Options for answers may include “nausea”, “headaches”, “vomiting”, “dizziness”, and “none”. A user may select one or more of the answers as a response to the question presented.

Previous answer(s) to question(s) presented may be retrieved (operation 440). Previous answers may be stored in a memory (e.g., local or remote to data management device 110) of the health management system. In some implementations, at least a portion of previous answers may be stored on a user's computer (e.g., user interface device 120).

The answers received may be compared to previous answers (operation 450). For example, the answers received may be compared to answers received the last time the user was presented the question or a similar question. Received answers may be compared to previous answers for a specified time period (e.g., last 6 months, duration of the treatment, etc.). Trends in answers received may be determined from the comparison.

Patient compliance with treatment regimens may improve a health condition and/or mitigate disease progression. Patient compliance with treatment regimens may also provide healthcare providers with a more accurate determination treatment efficacy (e.g., if a patient complies with treatment and a disease progresses, a new treatment regimen may be implemented). In addition, patient compliance may decrease costs associated with treating a user for a health condition by decreasing hospital and/or clinic visits associated with lack of compliance with treatment regimens. For example, in patients with rheumatoid arthritis, compliance with treatment regimens may decrease the number of visits to a hospital. Healthcare providers, such as insurance companies, may utilize health management system 100 to manage users' diseases, to facilitate tracking patient compliance, and encourage patient compliance, which may decrease costs for the healthcare provider.

Patient compliance with a treatment regimen may be determined from the comparison. If a treatment regimen includes a once-a-month injection and answers received indicate the user is taking the injection once-a-month, then the patient may be in compliance with a treatment regimen. A comparison of answers received to answers previously received may allow patient compliance to be tracked.

A response may be determined based on the comparison (operation 460). Responses may include messages to a user, healthcare providers, and/or third parties (e.g., payers, pharmaceutical companies, etc.). In some implementations, a response may not be taken if answers received and previous answers are within an allowable tolerance.

A determination may be made whether the deviation between answers received and previous answers are within an allowable tolerance (operation 470). If answers are within an allowable tolerance, a message may be transmitted (operation 480). For example, the message may indicate the patient is in compliance with the treatment regimen, include a reminder for a next scheduled doctor's appointment, and/or include a reminder for the next time a user should visit the website to answer questions again. The message may be transmitted to the user and/or healthcare providers (e.g., to facilitate tracking and monitoring of users health).

If answers are not within an allowable tolerance, a determination may be made whether the user should be contacted (operation 475). For example, a message may be transmitted to a healthcare provider indicating the user should be contacted (e.g., phone call from nurse, an e-mail from nurse, instant messaging or online chatting with a nurse, etc.). The user may be contacted if a determination is made that the user should be contacted (operation 476). For example, the user may receive a message, a phone call from a healthcare provider, an automated phone call, and/or a letter.

A determination may be made whether an appointment with a doctor should be schedule based at least in part on the answers to the questions (operation 477). For example, if a variance greater than an allowable tolerance exists, then a message may be transmitted to the user and/or healthcare provider to schedule a doctor's appointment. For example, if a patient's answer to pain increases from moderate to severe, a determination may be made that a doctor's appointment should be scheduled. As another example, if a patient answers that a treatment regimen is very difficult to follow, a determination may be made that a doctor's appointment should be scheduled. A doctor's appointment may be scheduled or requested, if a determination is made that a doctor's appointment should be scheduled (operation 478). For example, an e-mail may be sent to a doctor's office to schedule an appointment. As another example, a system that schedules doctor's appointments may be accessed to schedule an appointment for the user. As another example, a message (e.g., e-mail, automated phone call, fax, etc.) may be sent to the doctor's office to contact a user to schedule an appointment.

A determination may be made whether a treatment is effective (operation 490). Answers to questions may indicate management and/or maintenance of a health condition. For example, if pain is effectively managed (e.g., answer to level of pain does not increase above an allowable tolerance), then a treatment may be effective. As another example, if symptoms of a health condition do not worsen or increase (e.g., according to received answers), then a treatment may be effective.

In some implementations, a graphic display of disease progression, patient compliance, symptoms, side effects, and/or other information from the analysis of answers may be presented. A user and/or healthcare provider may utilize the graphic display to facilitate patient treatment. For example, graphic display of disease progression may facilitate the identification of trends associated with the health condition of the patient (e.g., seasonal increase in pain). As another example, a side effect profile may be generated. A user may print the graphic display and provide it to a health care provider to facilitate treatment of the user.

A graphic display of disease progression, patient compliance, symptoms, side effects, and/or other information from the analysis of answers may include an aggregation of results of analysis for a plurality of patients (e.g., with similar health conditions, with similar treatment regimens, with similar race, etc.). Healthcare providers, pharmacies, and/or pharmaceutical companies may utilize the generated graphic display to facilitate identification of problems with a treatment regimen (e.g., difficult to comply with regimen, side effects, and/or lack of efficacy), to formulate treatment regimens for other patients with similar health conditions, and/or to analyze pharmaceuticals.

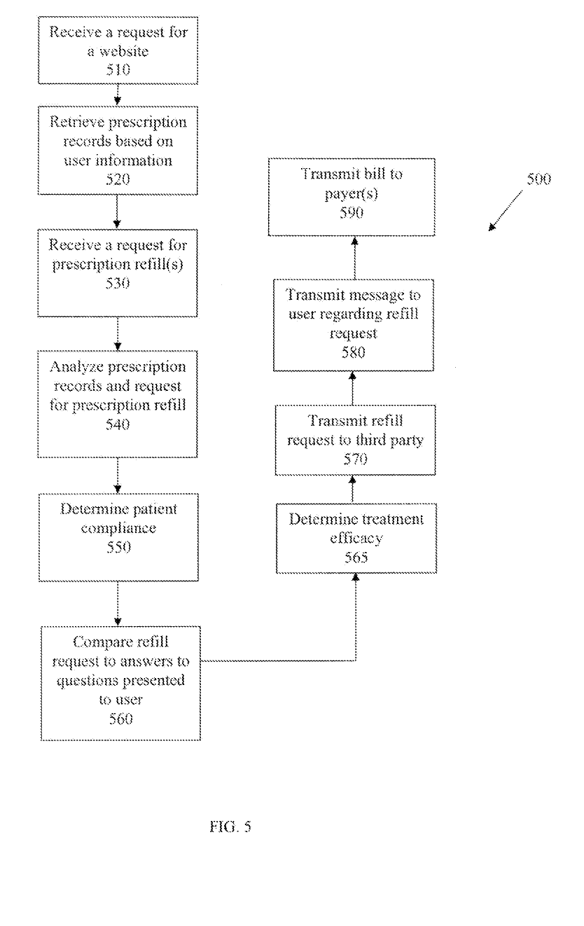

Although FIG. 5 and the accompanying description illustrate example process 400, system 100 contemplates using or implementing any suitable technique for performing these and other tasks. It will be understood that these processes are for illustration purposes and that described or similar techniques may be performed at any appropriate time, including concurrently, individually, or in combination. In addition, many of the steps in these flowcharts may take place simultaneously and/or in different orders than as shown. Moreover, system 100 may perform processes with additional steps, fewer steps, and/or different steps, so long as the processes remain appropriate. For example, an appointment with a doctor may not be requested. As another example, a user may be presented with one or more additional questions based on the analysis of the answers received.

FIG. 5 illustrates an example process 500 for refilling a prescription. Process 500 may be performed by health management system 100 illustrated in FIG. 1. Process 500 and process 200, 300, and/or 400 may be performed independently or in conjunction with one or more of the other processes.

In process 500, a request for a website may be received (operation 510). For example, a user may request access to a website coupled to health management system 100 to refill a prescription and/or manage a health condition. A user may provide user information such as a username and a password.

Prescription information based on user information may be retrieved (operation 520). Prescription information may include previous prescriptions, prescription history, available pharmacies, previously used pharmacies, possible side effects for various pharmaceuticals, counter-indications for various pharmaceuticals, generic and/or trade names for various pharmaceuticals, co-pays, coverage for various pharmaceuticals, and/or other information related to prescription information for the user. At least a portion of the prescription information for a user may be stored on memory 111 or remote memory 140 of the health management system 100. Health management system 100 may retrieve at least a portion of the prescription information for a user from remote systems 150 of a third party (e.g., healthcare provider or pharmacy). In some implementations, a user may be presented on the website with questions based on a health condition of a user, such as whether the user would like to fill a prescription. If the user answers the question as yes, prescription information for the user may be retrieved. If the user answers the question as no, the user may be presented with other questions based on a health condition of the user.

A request for one or more prescription refills may be received (operation 530). For example, a list of prescription available for refill may be presented to a user. A user may select a prescription for refill from a drop down menu and/or by entering a word identifying a prescription (e.g., nickname created by user, nickname created by another, prescription name, etc.). A request for a prescription refill may be for a future time period specified by the user. In some implementations, a healthcare provider such as a doctor may enter a prescription into the prescription records for a user. A user may then access the prescription via the website to fill the prescription. In some implementations, a user may request supplies associated with a prescription, such as syringes, swabs, testing strips, etc.

Prescription records and requests for prescription refill(s) may be analyzed (operation 540) and patient compliance may be determined (operation 550). For example, prescription refill requests may be compared to the last prescription request to determine if a user is complaining with the appropriate dosage (e.g., twice a day) of the prescription. In some implementations, side effects for a treatment regiment and/or symptomology may also be assessed.

In some implementations, a refill request may be compared to answers (e.g., received previously or currently) to questions presented to the user on the website (operation 560). For example, questions presented to the user may concern a health condition of the user, such as a disease of the user, treatment regimen, etc. Patient compliance, side effects, and/or disease progression may also be compared to the answers to the questions to determine the effectiveness of a treatment.

Treatment efficacy may be determined from the comparison of refill requests to answers (operation 565). For example, if prescription records indicate that a user is complying with dosage prescribed (e.g., user refills at appropriate times) and answers to questions indicate a health condition of a user is managed, decreasing, or increases, then a treatment efficacy may be determined. If a health condition is managed a treatment may be considered effective. In addition, prescription records and/or refill requests may be compared to answers to questions to determine patient compliance with a treatment regimen. For example, a user may answer that the user is taking a pharmaceutical daily, but the user may not have refilled the prescription for the pharmaceutical in over two months. Thus, a user's lack of compliance with a treatment regimen may be identified. In some implementations, the user may be contacted regarding compliance with the treatment regimen (e.g., to encourage compliance, to schedule a doctor's appointment regarding compliance, to determine if the treatment regimen is too difficult to follow, and/or to determine if the prescription was filled using a different source). The user may also be provided with educational materials to assist and to encourage patient compliance, to provide information regarding non-compliance, and/or to provide information related to disease progression, non-compliance, or other similar and pertinent information.

In some implementations, a refill request may be sent (e.g., via network protocols, via mail, automated phone call, etc.) to a third party, such as a pharmacy (operation 570). For example, health management system 100 may transmit a refill request via XML message to a remote system 150, such as a computer system for a pharmacy, which refills the prescription requested. As another example, health management system 100 may transmit a refill request by transmitting an e-mail or creating an automated phone call to request a prescription refill from a remote system 150, such as a pharmacy. A message to the user that the refill has been requested may be transmitted to the user (operation 580).

A bill for the refill requested may be transmitted to a payer (operation 590). A user may be a payer. As another example, an organization (e.g., healthcare provider, charity, etc.) may be a payer. For example, a charitable organization may pay bills for prescriptions for certain users. The organization may receive the bill directly from the health management system (e.g., rather than allowing the user to submit bills to the organization), which may reduce fraud due to bills submitted for pharmaceuticals not requested. As another example, a pharmaceutical company may pay at least a portion of a bill for certain users. Health care management system 100 may send the bill or the pharmaceutical company's portion of the bill directly to the pharmaceutical company. Sending the bill to the appropriate payer(s) may reduce the need for users to seek reimbursements and/or reduce fraud associated with fraudulent bills.

In some implementations, organizations may provide rebates, coupons, and/or debit cards to pay for at least a portion of a prescription for certain users. For example, an organization may issue $500 debit cards to assist users in paying for certain or any prescription. As another example, an organization may be contacted by another organization (e.g., charitable organization, pharmaceutical company, health care providers, etc.) to manage and/or provide debit cards, rebates or other forms of payment for prescriptions for certain users. Health management system 100 may be utilized to facilitate management of coupon, rebate, and/or debit card programs to pay for prescriptions or a portion of the cost of prescriptions for users. For example, a credit may be included on a user's account on health management system 100. As another example, a credit in the amount of a coupon or rebate may be applied to a user's refill request. Pharmacies and users may not be required to submit additional paperwork to be paid and/or reimbursed in accordance with the coupon and/or rebate, thus reducing costs and facilitating management of the coupon, rebate, and/or debit card program.

Although FIG. 5 and the accompanying description illustrate example process 500, system 100 contemplates using or implementing any suitable technique for performing these and other processes. It will be understood that these processes are for illustration purposes and that described or similar techniques may be performed at any appropriate time, including concurrently, individually, or in combination. In addition, many of the operations in these flowcharts may take place simultaneously and/or in different orders than as shown. Moreover, system 100 may perform processes with additional, fewer, and/or different operations, as long as the processes remain appropriate. For example, a bill may not be transmitted to a payer. As another example, persistence may be determined rather than or in addition to patient compliance. In addition, refill requests may not be compared to answers received to questions presented on the website.

In some implementations, data obtained from tracking disease progression and/or treatment efficacy may be provided to third parties (e.g., health care providers, pharmaceutical companies, pharmacies, etc.). For example, a health care provider, such as a health insurance, company may track disease progression and/or treatment efficacy to determine which prescriptions to include on covered formulary lists. A health care provider, such as a doctor, may track disease progression and/or treatment efficacy to determine a best course of treatment for a patient and/or to determine which treatments work for most patients during a stage of a disease. As another example, a pharmaceutical company may track disease progression and/or treatment efficacy to determine if a pharmaceutical performs as expected, to facilitate compliance with government standards (e.g., clinical trials) and/or health care provider standards (e.g., treatment efficacy of new pharmaceuticals), or for other pharmaco-economic studies or analyses.

In some implementations, a health management system may be utilized as a disease management program for a health care provider. Costs associated with treating many diseases, such as chronic and/or life-altering diseases (e.g., diabetes, rheumatoid arthritis, etc.), decrease when patients comply with a treatment regimen and/or when disease progression is mitigated. Thus, healthcare providers, such as insurance companies, may utilize health management system to decrease costs. For example, treatment of rheumatoid arthritis ranges from obtaining x-rays and treatment with ibuprofen to injectable therapies such as Enbrel®, commercially available from Amgen Corporation (Thousand Oaks, Calif.). Injectable therapies or other specialty therapeutics may be expensive although cost-effective when used as recommended. A healthcare provider may decrease costs by monitoring the compliance of a user on injectable therapy using a health management system and prompting nurses to contact users who are not compliant with a therapy regimen. For example, answers to questions presented to a user on injectable therapy may be analyzed to determine patient compliance, disease progression, and treatment efficacy. Based on the analysis, a nurse or other health care provider may contact user (e.g., via e-mail, phone call, letter, etc.) to discuss the treatment. Resources (e.g., nurses) may be more effectively allocated and/or costs may be decreased by prompting a response based on answers to questions rather than periodically contacting patients (e.g., via phone or requiring doctor's visits to ensure compliance) independent of treatment efficacy, disease progression, and/or compliance. For example, when a patient must be contacted, a nurse may have to call repeatedly (e.g., user not answering or home) before having the opportunity to discuss a health condition of a user. Decreasing the number of patients a nurse must contact decreases costs (since fewer nurses are needed) and allows nurses focus on patients who should to be contacted (e.g., based on changes in a health condition).

A health management system may also be used to determine treatment efficacy across a plurality of users. Doctors may utilize the determined treatment efficacy at least in part to determine treatment regimens for other users or users on a less effective treatment. Health insurance providers may utilize the determined treatment efficacy to generate preferred formulary lists and/or in determining which prescriptions to cover. As an example, a health management system may include one thousand users with severe rheumatoid arthritis. Five hundred users may take Drug A and the rest of the users may take Drug B. The users may be presented with questions about intensity of pain, frequency of pain, number of sick days from work, number of hospital visits, and/or number of days missed participating in enjoyable activities. The answers may be analyzed to determine which drug, if any, is more effective. The analysis may provide pharmaco-economics data, which may be utilized by a variety of parties such as healthcare providers, employers, and/or users, to decrease costs and/or facilitate health management across a plurality of users with a health condition. For example, health insurance companies may cover more of the costs associated with the more effective drug, may list the more effective drug on preferred formulary lists, etc. As another example, doctors may utilize the analysis to influence patient treatment and facilitate identification of other effective treatments. Employers may utilize the data on drug efficacy to increase coverage of certain drugs that allow workers to miss less days of work and/or identify drugs that cost less but provide similar effectiveness.

In some implementations, a heath management system may be utilized by pharmaceutical companies (e.g., manufacturers and/or distributors of pharmaceuticals). Pharmaceutical companies may utilize a health management system to increase compliance with treatment regimens, since profits increase with increased drug sales. Pharmaceutical companies may also utilize a health management system to obtain data for compliance with industry and/or governmental standards (e.g., U.S. FDA clinical trials, EU pharmaceutical standards, etc.). As an example, a health management system may be utilized by pharmaceutical companies in pre-Phase 4 U.S. FDA clinical trials. For example, Company X may want to prove that Drug Y, which has already passed Phase-3 U.S. FDA clinical trials, does not cause certain side effects, such as headaches or stomachaches, or that Drug Y causes less side effects than Drug Z. Questions presented to users taking Drug Y or Drug Z may include questions related to the side effects of the drugs. Thus, answers may be analyzed to determine if Drug Y does not cause certain side effects or causes less side effects than Drug Z. The answers may be used to determine if Phase-4 clinical trials should be performed (e.g., if the analysis determines that Drug Y does not cause the certain side effects, Phase-4 clinical trials may be performed; or, if analysis determines Drug Y causes the same amount of side effects as Drug Z, Phase-4 clinical trials may not be performed).

Furthermore, a health management system may allow a pharmaceutical company to monitor dispensing independent of the pharmacy chosen to refill the prescription. A more accurate model of dispensing may thus be obtained.

In some implementations, pharmacies may utilize a health management system to determine and monitor patient compliance. Pharmacies, such as specialty pharmacies which provide high cost pharmaceuticals, supplies, clinical support and/or education, may utilize a health management system to monitor patient compliance. Increasing patient compliance may increase profits for the pharmacy by reducing missed dosages or incorrect dosing. Additionally, refilling prescriptions online may result in cost savings for the pharmacy and provide an easy interface for a user to refill prescriptions.

In some implementations, a health care provider, such as an insurance company, may utilize a health management system to monitor and/or determine effectiveness of therapy changes. A health management system may allow an insurance company to access pharmaceutical information for a user as well as analysis and/or reports based on the analysis of answers to questions presented. An insurance company may utilize the data to decrease costs associated with treatment regimens by comparing costs of prescriptions with effectiveness of treatments.

In addition, insurance companies may use a health management system to monitor and/or facilitate patient compliance with treatment regimens. Compliance with treatment regimens may result in cost savings from decreased hospital visits. For example, a multiple sclerosis patient that complies with a prescribed treatment regimen may have two less hospital visits a year. Thus, utilizing a health management system may allow an insurance company to determine if the cost of covering the prescribed treatment regimen will be outweighed by the cost savings from less hospital visits.

In some implementations, a health management system 100 may be used for therapy management. Therapy management may include monitoring and/or analyzing a treatment regimen for one or more users. As an example, a user may access health management system 100 to monitor and track compliance with treatment regimens and/or disease progression. A user may provide information from the health management system 100 to healthcare providers to facilitate treatment of the user. A user may provide information from health management system 100 to healthcare providers, pharmacies, and/or other organizations to satisfy compliance requirements of healthcare providers, pharmacies, and/or other organizations (e.g., compliance required for discounted co-pays by a health insurance company, participation in the health management system required by health insurance company and/or pharmaceutical company that provides rebates, participation in health management system required for clinical trials, etc.). Therapy management using health management system 100 may be used by healthcare providers to determine approved, subsidized, and/or appropriate treatment regimens for health conditions and/or for various stages of a health condition.

In addition, therapy management using health management system 100 may be used by health care providers to facilitate and/or improve treatment of users. For example, answers from therapy management using the health management system 100 may be analyzed to determine therapy effectiveness and pharmaco-economic data. The analyzed answers may be used in treatment of the user who provided the answers and/or other users with similar health conditions.

Although a user has been described as a person, a user may be a single person, a group of people, a person or people entering data for a patient, a person or persons interacting with one or more computers, and/or a computer system, as appropriate.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device for displaying information to the user and a keyboard and a pointing device by which the user can provide input to the computer. Other kinds of devices can be used to interact with a user as well. For example, feedback provided to the user by an output device may be any form of sensory feedback (e.g., visual feedback, auditory feedback, and/or tactile feedback) and/or input from the user may be received in any form, including acoustic, speech, or tactile input.

The components of the system can be interconnected by any form or medium of digital data communication (e.g., a communication network). Examples of communication networks include a local area network (“LAN”), a wide area network (“WAN”), and the Internet.

A number of implementations have been described. Nevertheless, it will be understood that various modifications may be made. For example, answers to questions presented may be compared to allowable answers rather than or in addition to previous answers. As another example, a report may be generated that includes at least a portion of the results of the analysis of the answers received. Among other modifications, the described operations may be performed in a different order than is described and some operations may be added or deleted. A user may be presented with questions before and/or after requesting a refill of a pharmaceutical. As another example, a variance between received answers and previous answers may not be determined. Accordingly, other implementations are within the scope of this application.

It is to be understood the implementations are not limited to particular systems or processes described. It is also to be understood that the terminology used herein is for the purpose of describing particular implementations, and is not intended to be limiting. As used in this specification, the singular forms “a”, “an” and “the” include plural referents unless the content clearly indicates otherwise. Thus, for example, reference to “an answer” includes a combination of two or more answers and reference to “a pharmaceutical” includes mixtures of different types of pharmaceuticals.

1. A method of computerized therapy management, the method comprising:
receiving a request from a user for access to a website;
presenting questions based on user information, wherein the questions include questions related to a health condition of the user;
receiving answers to the questions;
analyzing the answers received; and
determining a response based on the analysis of the answers.

2. The method of claim 1 wherein the questions include at least one of questions related to a disease of a user, treatment of a health condition of a user, or questions related to symptoms of a user.

3. The method of claim 1 further comprising presenting one or more options for an answer to one of the questions presented.

4. The method of claim 3 wherein presenting one or more options for an answer includes presenting a range of answers.

5. The method of claim 1 wherein analyzing the answers includes comparing answers received to answers previously received from the user.

6. The method of claim 1 further comprising determining if the answers received are within an allowable tolerance of answers previously received from the user.

7. The method of claim 1 wherein the response includes transmitting a notice to a health care provider to contact the user.

8. The method of claim 1 wherein the response includes transmitting a notice to schedule an appointment with a doctor.

9. The method of claim 8 further comprising receiving a request for an appointment with a doctor, when the response includes transmitting a notice to schedule an appointment.

10. The method of claim 9 further comprising:
receiving answers to the questions from a plurality of users;
analyzing the answers received from the plurality of users; and
determining at least one of patient compliance among the plurality of users, patient persistence among the plurality of users, treatment efficacy among the plurality of users, pharmaco-economic information, or disease progression among a plurality of users.

11. A computerized method of refilling a prescription, the method comprising:
receiving a request from a user for access to a website;
accessing prescription records based on user information;
receiving a request to refill one or more prescriptions for the user; and
determining patient compliance based on the prescription records and the request.

12. The method of claim 11 further comprising transmitting the request to refill one or more prescriptions to a pharmacy.

13. The method of claim 11 further comprising transmitting a bill associated with the request to refill one or more prescriptions to a payer.

14. The method of claim 11 wherein determining patient compliance includes determining the amount of time lapsed between receiving the request to refill a prescription and the previous request to refill the same prescription.

15. The method of claim 11 further comprising determining effectiveness of a treatment based at least in part on the determined patient compliance.

16. The method of claim 11 further comprising:
presenting questions based on user information, wherein the questions include questions related to a health condition of the user;
receiving answers to the questions;
analyzing the answers received; and
determining a response based on the analysis of the answers.

17. The method of claim 16 further comprising comparing patient compliance with the answers to the questions to determine effectiveness of a treatment.

18. The method of claim 11 further comprising receiving a request for supplies related to a health condition of a user.

19. An article comprising a machine readable medium storing instructions operable to cause one or more machines to perform operations for therapy management comprising:
receiving a request from a user for access to a website;
presenting questions based on user information, wherein the questions include questions related to a health condition of the user;
receiving answers to the questions;
analyzing the answers received; and
determining a response based on the analysis of the answers.

20. The article of claim 19 wherein the instructions are further operable to cause one or more machines to perform the method steps comprising:
accessing prescription records based on user information;
receiving a request to refill one or more prescriptions; and
determining patient compliance based on the prescription records and the request.

21. A health management method for coordinating, between a group, the management and/or monitoring of the treatment or progression of a patient's health condition, the group consisting of the patient, at least one health care professional, at least one health care provider, at least one pharmacy, and at least one pharmaceutical company, the method comprising:
providing a website with an interface for access by a member of the group;
generating a set of questions for the patient based on the patient's information, wherein the set of questions comprises one or more questions related to the health condition of the patient;
obtaining the patient's answers to the questions;
analyzing the answers to obtain results in various pre-specified data formats;
presenting the appropriate result to the appropriate member based on the member's access privileges; and
notifying the appropriate member if a predetermined event occurs.

22. The health management method of claim 21 wherein an additional subset of the questions is identical to questions asked and answered previously in order to more closely track disease progression.

23. The health management method of claim 21 wherein the data formats comprise: treatment compliance; treatment efficacy; patient symptoms; side effects of pharmaceuticals used; pharmacoeconomic data; and disease progression.

24. The health management method of claim 21 further comprising:
aggregating the results of a plurality of patients to facilitate pharmacoeconomic analysis.

25. The health management method of claim 21 further comprising:
providing an incentive to the patient to obtain his or her participation.

26. The health management method of claim 21 wherein at least a portion of the results are aggregated across a plurality of patients and provided to at least one pharmaceutical company for use in clinical trials.

27. A health management system for coordinating, between a group, the management and/or monitoring of the treatment or progression of a patient's health condition, the group consisting of the patient, at least one health care professional, at least one health care provider, at least one pharmacy, and at least one pharmaceutical company, the system comprising:
a data management device comprising:
a processing device;
a website server; and
a database,
wherein the data management device performs the method steps comprising:
providing a website with an interface for access by a member of the group;
generating a set of questions for the patient based on the patient's information, wherein the set of questions comprises one or more
questions related to the health condition of the patient;
obtaining the patient's answers to the questions;
analyzing the answers to obtain results in various pre-specified data formats;
presenting the appropriate result to the appropriate member based on the member's access privileges; and
notifying the appropriate member if a predetermined event occurs.

28. The health management system of claim 27 wherein an additional subset of the questions is identical to questions asked and answered previously in order to more closely track disease progression.

29. The health management system of claim 27 wherein the data formats comprise: treatment compliance; treatment efficacy; patient symptoms; side effects of pharmaceuticals used; pharmacoeconomic data; and disease progression.

30. The health management system of claim 27 further comprising:
aggregating the results of a plurality of patients to facilitate pharmacoeconomic analysis.

31. The health management system of claim 27 further comprising:
providing an incentive to the patient to obtain his or her participation.

32. The health management system of claim 27 wherein at least a portion of the results are aggregated across a plurality of patients and provided to at least one pharmaceutical company for use in clinical trials.

33. A computer program product comprising a computer-readable medium having instructions, the instructions being operable to enable a computer to execute a procedure for coordinating, between a group, the management and/or monitoring of the treatment or progression of a patient's health condition, the group consisting of the patient, at least one health care professional, at least one health care provider, at least one pharmacy, and at least one pharmaceutical company, the program instructions comprising:
providing a website with an interface for access by a member of the group;
generating a set of questions for the patient based on the patient's information, wherein the set of questions comprises one or more questions related to the health condition of the patient;
obtaining the patient's answers to the questions;
analyzing the answers to obtain results in various pre-specified data formats;
presenting the appropriate result to the appropriate member based on the member's access privileges; and
notifying the appropriate member if a predetermined event occurs.

34. The computer program product of claim 33 wherein an additional subset of the questions is identical to questions asked and answered previously in order to more closely track disease progression.

35. The computer program product of claim 33 wherein the data formats comprise: treatment compliance; treatment efficacy; patient symptoms; side effects of pharmaceuticals used; pharmacoeconomic data; and disease progression.

36. The computer program product of claim 33, the program instructions further comprising:
aggregating the results of a plurality of patients to facilitate pharmacoeconomic analysis.

37. The computer program product of claim 33, the program instructions further comprising:
providing an incentive to the patient to obtain his or her participation.

38. The health management system of claim 33, the program instructions wherein at least a portion of the results are aggregated across a plurality of patients and provided to at least one pharmaceutical company for use in clinical trials.
